(19) United States
(12) Patent Application Publication
(10) Pub. No.: US 2004/0250106 A1
(43) Pub. Date: Dec. 9, 2004

(54) System and method for preventing sharing of music, video, video games and software

(76) Inventors: Steven A. Annese, Secaucus, NJ (US); Keith W. Valpone, Encino, CA (US)

Correspondence Address: Philip M. Weiss, WEISS & WEISS, Suite 201, 310 Old Country Road, Garden City, NY, 11530, US

(21) Appl. No.: 10/443,239

(22) Filed: May 21, 2003

(51) Int. Cl. H04L 9/00

(52) U.S. Cl. 713/200

(57) ABSTRACT

A system and method for preventing sharing of music, video, video games and software over the Internet.

### FIELD OF THE INVENTION

The present invention relates to a system and method for preventing sharing of music, video, video games and software over the Internet.

### BACKGROUND OF THE INVENTION

The Internet has brought great deals of efficiency world-wide. The problem is the Internet can also be used as a tool for illegal activity. Illegal activity of copyrighted material such as online music or better known as MP3's. It has become apparent that the Internet and peer-to-peer technology is a detriment to the music industry now and for years to come. Digital Rights Management (DRM) and CD Copy protection schemes have not worked effectively in protecting the intellectual property rights of performers.

While online sales continue to increase by outstanding percentages year-over-year, music sales has lagged and is suffering. The music, video and software industry is in a difficult period as peer to peer technologies emerge on a daily basis and people exploit this loop hole.

Since the inception of Napster, music piracy has run rampid. Once Napster was taken down, many other companies popped up.

### SUMMARY OF THE INVENTION

The present invention relates to an extensive network infrastructure that in conjunction with artists and music labels allows music, video, video games and software to be protected in various forms online. It is an object of the present invention for the music to be in formats, such as, MP3, Windows Media Player, Real Player. It is an object of the present invention for the transmission of the fake material to be incomplete transparent to the downloading offender.

The present invention relates to a method for stopping unauthorized distribution of music, films/videos, video games, software or other copyrighted material over the Internet. The method comprises receiving digital content. A file is created which contains part of the original content received. The file is then sliced and looped with other content to create a completely new file. A new digital file is created. The new digital file can contain any portion of the original digital content. For example, the new digital file can comprise about ¼ to about ½ of the original digital content. It is an object of the present invention for the system to add blanks within a specified time slice interval to the newly created file. It is an object of the present invention for the newly created file to be the same size as the original digital content file received. It is an object of the present invention to create multiple new digital files. It is an object of the present invention to convert the digital content into MP3 format. It is an object of the present invention to place descriptions labeled into a filename where every possible search can be done to return an accurate database listing for peer to peer retrievals. It is an object of the present invention to create keyword identifiers to match database searches by users.

The present invention relates to a system for stopping unauthorized distribution of music, films/videos, video games, software or other copyrighted material over the Internet. The system comprises a database for receiving digital content files. The system takes the digital content received and creates a new file which comprises part of the digital content file and other fill-ins to create a totally new file. For example, the new file can include about ¼ to about ½ of the digital content file. For music, the digital content can be other sounds to fill in the space. For video, the digital content can be video unrelated to the copied digital content.

It is an object of the present invention for the new files to comprise partial content of the original file alone with blanks added within a specified time slice interval. It is an object of the present invention for the new file to be the same size as the digital content file. It is an object of the present invention for the system to create multiple new digital content files. It is an object of the present invention for the system to convert the digital content files into MP3 format. It is an object of the present invention for the newly created files to have descriptions labeled into a filename where every possible search can be done to return an accurate database listing for peer to peer retrievals. It is an object of the present invention for the system to create keyword identifiers to match database searches by users.

It is an object of the present invention for the system to comprise a network infrastructure with large data storage for snip-its of copyrighted material, including but not limited to music, videos/motion pictures and software.

### DETAILED DESCRIPTION OF THE INVENTION

For example, if music is being used, the process of the present invention creates a snip-it to receive music in digital format. Once receiving the digital content, the system of the present invention either loops the song, for example ¼ or ½ way into the music or adds blanks within a specified time slice interval. The newly created file will have the same size as the original song and therefore appear to the user to be a complete song. The system of the present invention creates multiple file sizes of the same content to disguise the invalid types to the community. The system of the present invention converts the digital form into the current MP3 format and can also convert the digital form into any new technology that can potentially replace MP3 .

Once all these processes have been implemented, it will make the digita useless (for either listening or recording/burning). The system of the present invention has descriptions labeled into the filename where every possible search can be done to return an accurate database listing for peer to peer retrievals.

The following is an example of the process of the present invention.

The system of the present invention receives the copyrighted digital content before it is presented to the market place. The present invention creates slices and loops the material in specified digital intervals. For example if the song is 3 minutes and 20 seconds long, the system could create a file using the first minute of the song and then create fragments of sound to increase the file size for the remaining 2 minutes and 20 seconds. This makes the file size identical to the original file that consumers buy on the record, however it creates an unidentifiable decoy for those wishing to unlawfully download the material.

In a preferred embodiment, the system of the present invention creates keyword identifiers to match database searches by the peer to peer community.

The present invention implements a network infrastructure with large data storage for snip-its of copyrighted material, including but not limited to music, videos/motion pictures and software. There are many nodes attached to the network which are subscribed to all the major peer to peer networks and sharing devices to offer a floodgate of snip-its of copyrighted material. The present invention makes it much more difficult for peer-to-peer subscribers to download complete working copyright material. Once downloading of the snip-it begins in the peer-to-peer community, it is extremely viral and virtually unstoppable. Users will have to download and listen to hundreds of damaged files. Finding a complete file will be like winning the lottery.

1. A method for stopping unauthorized distribution of music, films/videos, video games, software or other copyrighted material over the Internet comprising:
receiving digital content;
creating a partial file for part of the digital content received;
slicing and looping said digital content;
creating a new digital file.

2. The method of claim 1 wherein said partial file includes about ¼ to about ½ of said digital content.

3. The method of claim 1 further comprising:
adding blanks within a specified time slice interval.

4. The method of claim 1 wherein said new digital file has same size as said digital content.

5. The method of claim 1 further comprising:
creating multiple new digital files.

6. The method of claim 1 further comprising:
converting said digital content into MP3 format.

7. The method of claim 1 further comprising placing descriptions labeled into a filename where every possible search can be done to return an accurate database listing for peer to peer retrievals.

8. The method of claim 1 further comprising;
creating keyword identifiers to match database searches by users.

9. A system for stopping unauthorized distribution of music, films/videos, video games, software or other copyrighted material over the Internet comprising:
a database for receiving digital content files;
said system creating a new file;
said new file comprising part of said digital content file and other fill-ins to create a total file.

10. The system of claim 9 wherein said new file includes about ¼ to about ½ of said digital content file.

11. The system of claim 9 wherein said new file comprises;
blanks added within a specified time slice interval.

12. The system of claim 9 wherein said new file has same size as said digital content file.

13. The system of claim 9 wherein said system comprises:
multiple new digital content files.

14. The system of claim 9 further wherein said system converts said digital content files into MP3 format.

15. The system of claim 9 wherein said new files have descriptions labeled into a filename where every possible search can be done to return an accurate database listing for peer to peer retrievals.

16. The system of claim 9 wherein said system creates keyword identifiers to match database searches by users.

17. The system of claim 9 further comprising;
a network infrastructure with large data storage for snip-its of copyrighted material, including but not limited to music, videos/motion pictures and software.
